(19) United States
(12) Patent Application Publication
(10) Pub. No.: US 2008/0209907 A1
(43) Pub. Date: Sep. 4, 2008

(54) Solar-architectural material and building integrative solar energy utilization

(76) Inventors: Wenzhao Xiao, Beijing (CN); Zheng Xiao, Beijing (CN); Hong Xiao, Millburn, NJ (US); Li Xiao, Hoffman Estaters, IL (US)

Correspondence Address: Wenzhao Xiao, Apt. 0205, Section 2, Building 2, Fang-Jing-Yuam, Gan-Lu-Yuam, Chaoyang District, Beigjing, 100025, CN

(21) Appl. No.: 11/999,954

(22) Filed: Dec. 8, 2007

(30) Foreign Application Priority Data
May 30, 2007 (CN) 200710105783.X

(51) Int. Cl. F03G 6/00; E04D 13/18; F24H 7/00; F24J 2/00; F24J 2/08

(52) U.S. Cl. 60/641.15; 126/621; 126/400; 126/569; 126/683

(57) ABSTRACT

The present invention provides a kind of solar-architectural materials which receive solar radiation and transfer it into heat energy and at the same time works as building finishing and decoration material, and thereof a system of building integrative solar heat utilization in which comprise a kind of heat-energy-conflux-device via metal matching surface impinging on each other without leakage possibility of liquid as heat transfer medium in the system.

### REFERENCES CITED (REFERENCED BY) U.S. PATENT DOCUMENTS

| | | |
|---|---|---|
| 4,269,171 | May 26, 1981 | McArthur; William H. |
| 4,289,116 | Sep. 15, 1981 | Williams; Robert H. |
| 4,425,906 | Jan. 17, 1984 | Ingestrom; Curt H. |
| 4,438,759 | Mar. 27, 1984 | Kitajima; Soichi (Nara, JP), Iwamura; et al. |

### FOREIGN APPLICATION DATA

| | | |
|---|---|---|
| Date: May 30, 2007 | Code: CN | Application Number: 200710105783.X |

### FIELD OF THE INVENTION

This invention relates to a kind of solar-architectural materials and thereof a system of building-integrative solar heat utilization; in particular to a kind of improved apparatus and method to be built within the roof and/or awnings and/or walls towards the sun light for receiving the radiant energy from the sun and converting it into heat which be collected into a liquid medium system for storing up, distribution and utilization.

### BACKGROUND OF THE INVENTION

The conventional solar heating panels are used for collecting solar heat energy to heat water as independent devices, but not for large scale systems due to problems such as leakage risk, being frozen, need place to install and not very competitive cost;

The solar house heating systems, in which air to be used as heat-transfer medium, need special designed and extra structure of building and the collected heat energy via air medium is not so easy to conflux, nor so easy to be stored in and re-distributed. And noise due to air flow may cause trouble with the residents;

The Solar heating system for greenhouse is not very suitable for living building, not for commercial building due to water leakage possibility and architectural reasons;

The solar collecting elements of heat-pipe or inorganic-thermal-device with fins are better than the others referring to heat-transfer and adaptability to diversified temperature area; but until now, they are used for independent devices via inserting the head of heat-pipe or inorganic-thermal-device into a water tank, leakage risk is still existing.

### SUMMARY OF THE INVENTION

This invention provides a kind of solar-architectural materials and thereof a system of building-integrative solar energy utilization. In particular to provide a kind of improved solar apparatus and method to be built within the roof and/or awnings and/or walls towards the sun light for receiving the radiant energy from the sun and converting it into heat which be further collected, via a heat-energy-conflux-device of metal matching surfaces impinging on each other, into a liquid medium system for storing up, distribution and utilization. Therefore, the solar apparatus of this invention exclude leakage risk and improve away the problems such as visual pollution, being frozen and place-occupancy for installing the conventional solar devices, and therefore, upgrade the cost efficiency.

Another object of this invention is to make buildings simultaneously with both benefits: maximum solar energy collection and high efficient insulation for both heating and cooling by reasonable cost at different time the whole day and the whole year around; further more, this invention make it commercially feasible that to have buildings with very low energy consumption and very low emission of carbon dioxide.

The solar-architectural materials in this invention comprise of metal plates made into integrative with heat-pipe or inorganic-thermal-device which normally is located in the width middle of metal plate. The said solar-architectural materials, i.e. the elements of solar energy collecting, are designed for both solar and architectural purpose.

As for the said architectural purpose

The said heat-pipe or inorganic-thermal-device may have various cross-section profile shapes, such as round, ellipse, rectangle or square or polygons normal or with rounded corner, or shapes enveloped by various kinds of curves and/or zigzag lines, depending on the actual situation.

The said heat-pipe or inorganic thermal device may be whole or partially located in front of the metal plate, or being hidden behind it, depending on the architecture.

The said metal plate may have various shapes such as flat, waved, corrugated, fine or markedly dented or protruded, with or without decorative patterns and with some different dark color and with or without de-reflection coating of nice color, depending on the architecture.

There will be various type of joints among the said metal plates, such as inter locking, overlapping, inserting by tongue and groove, flange and screw and so on, depending on the actual situations.

For the solar purpose

The said heat-pipe or inorganic thermal devices are the heat transfer elements integrative with the metal plates which are solar energy collect elements. The surface of said metal plates is treated by light-selective-absorbing material in order to get high efficiency of solar collection.

The said heat-pipe or inorganic thermal devices have a head with special shape which meets the requirement of heat-energy-conflux-device via which the heat energy from plurality of heat transfer elements (the said heat-pipe or inorganic-thermal-devices) is collected into a metal duct or pipe in which a kind of heat-transfer-medium flows through. The said heat-transfer-medium commonly is purified water or water solution of anti-freeze or other liquid;

The said heat-energy-conflux-device is comprised of matched surfaces impinging on each other and a special fitting. The heat energy is conducted by metal from the plurality of heat transfer elements to the metal duct or pipe in which heat-transfer-medium flows through. In such a way, there will never be leak possibility. Among the said two surfaces tightly matched, one is on the head of said heat-pipe or inorganic-thermal-device, another is on the metal duct or pipe in which heat-transfer-medium flows through. The said fitting is made from metal or graphite or other materials with good heat conductivity and it makes two contacting surfaces impinging on each other, and makes up or enhances the heat conduct capacity also. Preferably, the said fitting will be integrative with either the metal ducts or pipe, or heads of heat-pipe or inorganic-thermal-devices by integrative fabrication or welding or metallurgical bonding. There is or no heat-conductive agent between the said two matched surfaces, depending on the actual situations.

The said building-integrative solar heat utilization system is comprised of two sectors: solar apparatus and utilization equipment.

The said solar apparatus is built within the roofs and/or the walls and/or the awnings and is comprised of transparent cover for admitting the sun light in and isolating the weather, plurality of solar collect units made of solar-architectural materials, heat-energy-conflux-devices, ducts or pipe of heat-transfer-medium, insulation materials. For existing buildings, the said solar apparatus will be made as assembled modules and to be applied on roofs and/or on walls and/or on awnings.

The said utilization equipment is comprised of pipe, valves, heat exchanger and/or boiler, storage-tank, distributor, auxiliary heater, sensors and control device and heat application equipment.

### BRIEF DESCRIPTION OF THE DRAWINGS

The methods and features and advantages of this invention will be more specifically and exactly described in the following context and the accompanying drawings, in which:

FIG. 1 is the most simplified sketch map of the said solar-architectural materials in which the basic shape and components of the said solar-architectural materials is illustrated;

FIG. 2 is a schematic diagram of the said building-integrative solar heat utilization system;

FIG. 3 is the specific illustrations of the said heat-energy-conflux-device of a set of metal matching surface enforced impinging on each other;

FIG. 4 is a sectional view of the said building-integrative solar apparatus showing layer by layer configuration within the roof and/or wall and/or awnings;

FIG. 5 shows the sectional profile shape of transparent roof cover with flanges at the longitudinal sides, FIG. 5A shows flat one, FIG. 5B shows waved one to be used as longitudinal convex lens for focusing the sun light

FIG. 6 shows the sectional profile shape of flat transparent roof cover with side drain channel at the longitudinal side

FIG. 7 shows a solar receiving unit put in a glass tube with vacuum jacket, reflective focus mirror and plug(s), in order to get solar energy with temperature significantly higher than 100° C.

FIG. 8 shows the front views of said building-integrative solar apparatus installed above windows and gates as awnings.

### DETAILED DESCRIPTION OF THE INVENTION

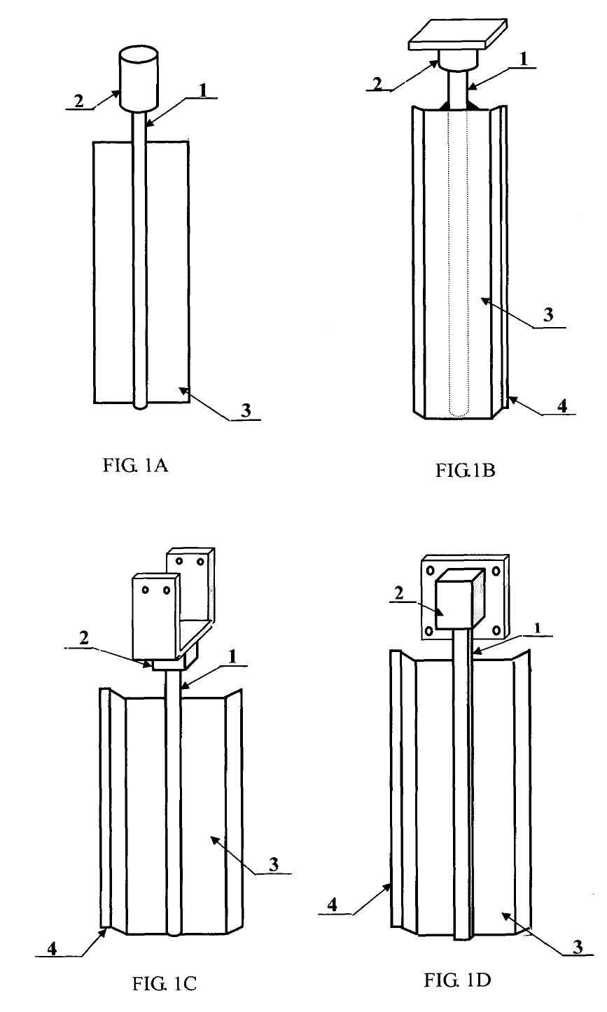

In FIG. 1, the said solar and architectural materials, i.e. the elements of solar energy collecting, are illustrated by 4 drawings: A, B, C and. D, in which: 1 is the body of heat-pipe or inorganic-thermal-device working as the first stage of heat energy collector and heat-transfer pass;

The said body of heat-pipe or inorganic-thermal-device may have various cross-section profile shapes, such as round in FIG. 1A, B, C; ellipse; rectangle or square, such as in FIG. 1D; or polygons, normal or with rounded corner; or shapes enveloped by various kinds of curves or zigzag lines; depending on the actual situation; even in the longitude direction, the body of heat-pipe or inorganic-thermal-device may have various decorative shapes or designs.

The said heat-pipe or inorganic thermal device may be whole or partially located in front of the metal plate, such as in FIGS. 1A and C, or being hidden behind it, such as in FIG. 1B, depending on the architecture.

2 is the head of heat-pipe or inorganic-thermal-device. The heads have to have a area with special shape and perfect surface condition to meet requirement of heat-energy-conflux-device working as heat releaser where the heat energy will be transferred into a liquid medium system from heat-pipe or inorganic-thermal-device via the heat-energy-conflux-device; the section profile shape and dimension of said heads are either same as or different from the body of heat-pipe or inorganic-thermal-device; said area with special shape can be at a side or top of said heads depending on the actual situation;

3 is the solar energy receiving plate made from metal with good heat conductivity which have functions both for solar and architectural. For architectural purpose, the said metal plates may have various shapes such as flat, waved, corrugated, fine or markedly dented or protruded, with or without decorative patterns and so on; and with some different dark color and with or without de-reflecting coating of nice color, depending on the architecture; For solar purpose, the metal plates are solar energy receiving portion and their surfaces are treated by light-selective-absorbing materials in order to get high efficiency of solar collection. For special purpose, a plurality of heat-pipe or inorganic thermal devices will be integrative in one piece of metal sheet in order to reduce joints and provide more area for architecture.

4 is the margin along the long edge for joint between elements of solar energy collecting. There will be various type of joints among the said metal plates, such as inter locking, overlapping, inserting by tongue and groove, flange and screw and so on, depending on the actual situations. No specific shape or structure of joints are illustrated in the drawings; in this invention, there are nothing preventing from any joint shape or structure to be manufactured or used,

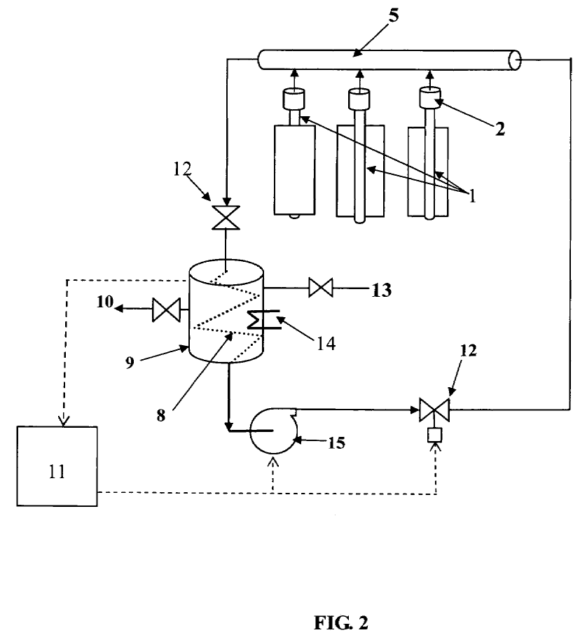

FIG. 2 is a most simplified schematic diagram of the said building-integrative solar heat utilization system, in which: 1 is the body of heat-pipe or inorganic-thermal-device and 2 is the head of heat-pipe or inorganic-thermal-device, the same as in FIG. 1, 5 is metal pipe working as duct of the heat-transfer-medium and a portion of heat-energy-conflux-device; In the actual system, there will be a plurality of such metal pipe and heat-energy-conflux-device, among them, there will be a plurality of connection modes such as in series (tandem), parallel, and both mixed depending on collected energy amount and temperature requirement; 11 is a control device to control the pump (15) valves(12) and change the pipe connection mode or configuration according to signals from sensors installed in storage-tanks(9) and elsewhere; Based on this invention, the system will meet demands for different applications:

For building heating and hot water supply: For such a system, there are two options: one is usage water directly flow through the said duct or pipe working as component of heat-energy-conflux-device to be heated without pump and heat exchanger; another is to use a heat-transfer-medium (purified water or water solution of anti-freeze or other liquid.) cycling system separating from the usage water system by a heat exchanger (8), 13 is the usage water source and 10 will be the application equipment; 14 would be a back-up (non solar) heat source if the system to be so designed;

For commercial or industrial use (including air-conditioning): where it needs elevated temperature such as significantly higher than 100° C.; For such a system, 9 will be a pressure vessel and/or boiler and the application system needs a proper heat-transfer medium also;

Generation of electrical power using turbine: this invention provides solution to generate electrical power utilizing solar heat energy. For such a system, 9 will be a boiler heated by heat energy collected by the apparatus and technology of this invention; and 14 will be turbine; those and condensator and some related equipment will comprise a cycling loop with the working medium which will be water or some other kind of chemicals with lower boiling point and evaporation latent heat than water with while the heat-transfer-medium in the solar apparatus (in metal pipe—5) will be some type of chemicals which is suitable to work at the relevant temperature; it is preferable to comprise a comprehensive application of power and heating while the turbine works with a condensator at proper temperature, for example around 60° C., and it will make high overall efficiency;

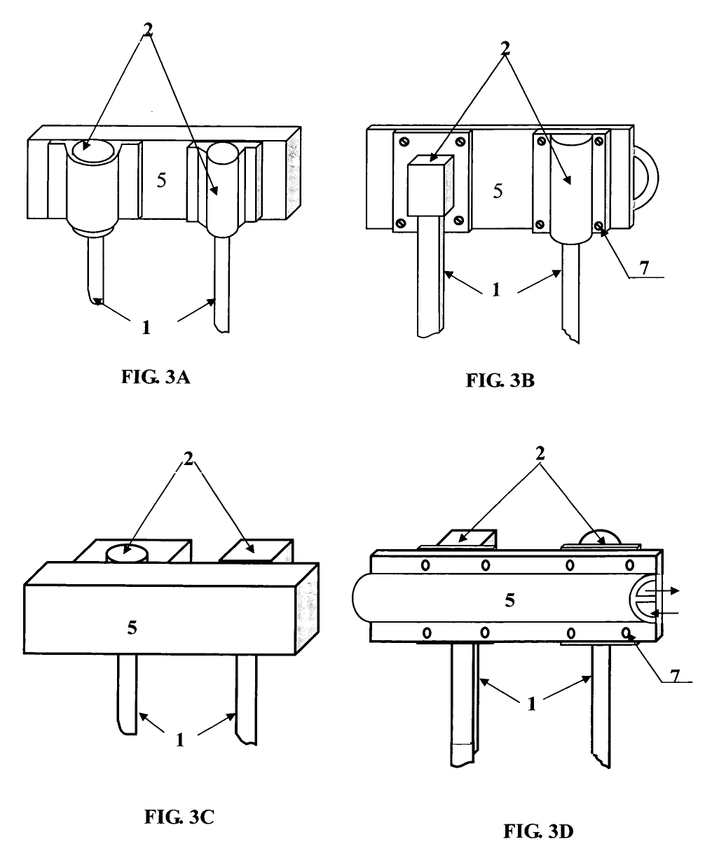

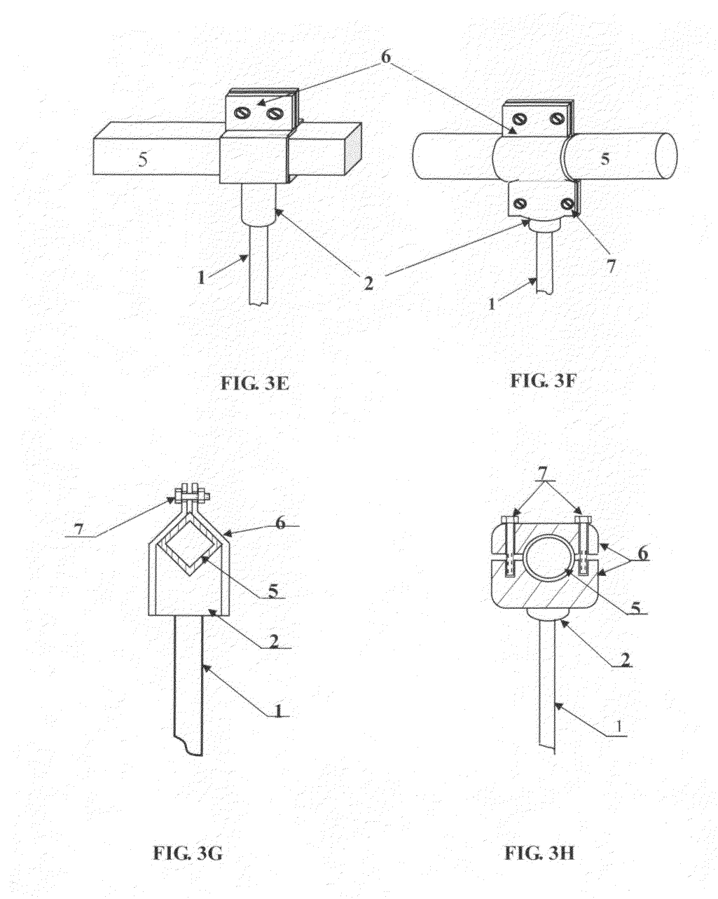

FIGS. 3, A, B, C, D, E, F and G are the specific illustrations of the said heat-energy-conflux-device; In FIGS. 3:A, B, C, D, E, F, and G, 1 is the bodies of heat-pipe or inorganic-thermal-device and 2 is the heads of heat-pipe or inorganic-thermal-devices, 5 is metal duct or pipe, the same as in FIG. 2.

Said heat-energy-conflux-device is comprised of a set of metal matching surfaces and to be enforced impinging on each other. One of the matching surfaces is on the head of heat-pipe or inorganic-thermal-device, another is on the metal duct or pipe 5 (of heat-transfer-medium); As the examples, in FIGS. 3A and B, the ducts' section profile is square or rectangle and in its front side there is a perfect flat area which is one of the matching surfaces, the other is similar flat surface on the heads of heat-pipe or inorganic-thermal-devices; for the head without flat area, one piece of metal with a perfect flat surface and good heat conductivity is integrative with it, or the head is made into half fiat; In FIGS. 3C and D, the things are near the same as in FIGS. 3A and B, but the perfect flat surface is on the back side of the duct, instead of front side; In FIGS. 3E and F, one of the matching surface is at the bottom side of the duct, the others are on the top of the heads of heat-pipe or inorganic-thermal-devices; in FIG. 3F, the duct is a round pipe, the matching surface on the head (of heat-pipe or inorganic-thermal-devices) is curved and perfect matched with bottom side of the round pipe; in FIG. 3G, the section profile of duct is a rhombus or rectangle or square or polygons, the matching surface on the head of heat-pipe or inorganic-thermal-devices is a “V” shape groove, combining an arris/groove match by a proper special fitting fastened and enforced tightened;

In this invention, said ducts' or pipe section profiles will be various, such as round, ellipse, semi-round and semi-ellipse, rectangle or square or polygons normal or with rounded corner, or shapes surrounded with various kinds of curves and/or zigzag lines depending on the actual situation; A key point is that the ducts have area composing sets of perfect matching surfaces with the relevant area on the heads of heat-pipe or inorganic-thermal-devices;

6 is the fitting for installation and tightening of said matching surfaces; it is made of metal or graphite or compound materials with necessary strength and good heat conductivity; and it makes up or enhances the heat conduct capacity, therefore, its inside surface will get partially perfect matching both with the duct and the head of heat-pipe or inorganic-thermal-devices; said fitting 6 is needed for every type of heat-energy-conflux-device in this invention; it is preferred that the fitting to be integrative with either the ducts or the heads of heat-pipe or inorganic-thermal-devices by integrative fabrication or welding or metallurgical bonding; 7 are fasteners to fasten the fittings and provide force for enforcing them tightly;

For some special applications, it is preferred that to make metallurgical bonding between said metal matching surfaces by some type of special technologies such as ultrasonic bonding, ultrasonic brazing, induction brazing and the like, while said metal matching surfaces being installed and forced tightened by said special fitting;

There will be or will be no heat-conductive agent between the said matching surfaces, depending on the actual situations;

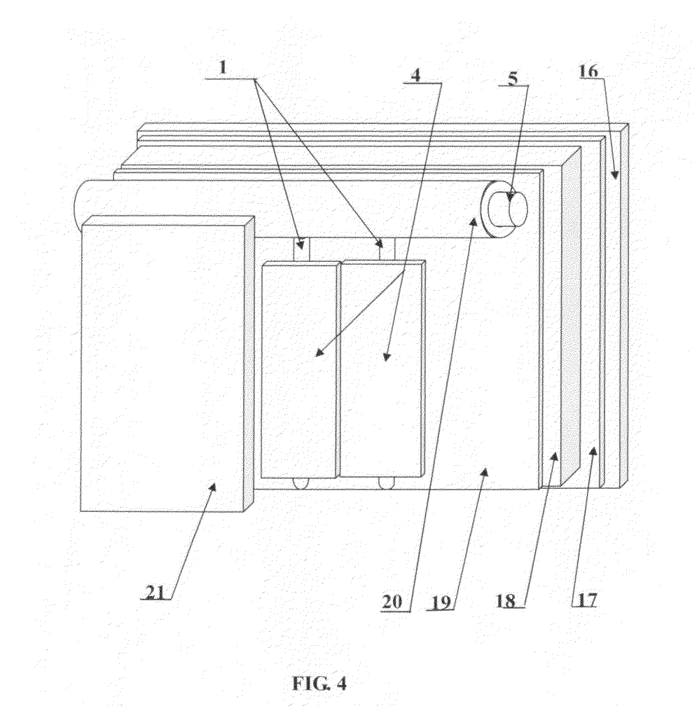

FIG. 4 is a sectional view of the said building-integrative solar apparatus showing layer by layer configuration within the roof and wall, In which: 1 is the body of heat-pipe or inorganic-thermal-device and 3 is the solar energy receiving plate with architectural function, same as in FIG. 1; 5 is metal duct or pipe, the same as in FIG. 2; 16 is the interior wall boards or the bottom board of roof structure; 17 is aluminum foil at least 1 layer with joint reasonable overlapped, 18 is insulation boards comprised of at least 2 layers whose joints staggered; 19 is aluminum foil, at least 2 layers whose joints staggered; 20 is insulation materials with aluminum foil cover and liner whose joints staggered; aluminum foil has functions: to reflect infrared rays from the solar receiving plates in the day time and also reflect infrared rays from the room inside; to isolate water (as humidity) migration and air convection caused by temperature difference;

Said metal duct or pipe, body portion of heat pipe or inorganic-thermal-device above the solar energy receiving plate and fitting of thermal-energy-conflux-device will be covered by a specially designed decoration to hide the things which look like not very nice;

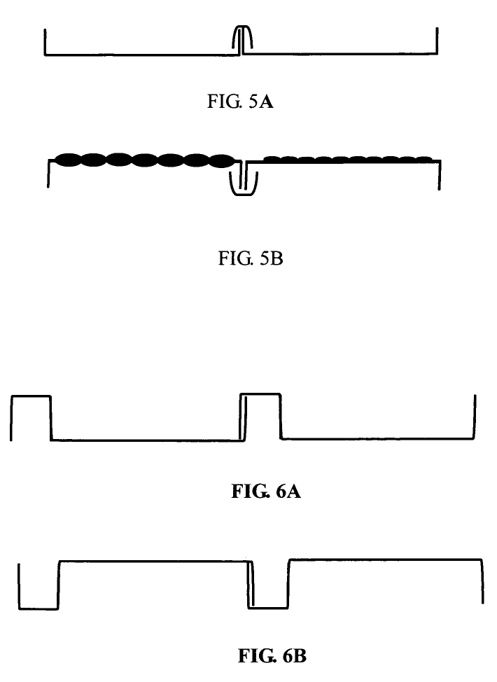

21 is the transparent cover to admitting sun light in and isolate the weather, it is comprised of glass or tempered glass or board of synthetic materials; it is preferably to be treated as de-reflective to get higher efficiency; it may be treated with obscured decoration pattern or design on inside surface; said transparent cover have various shapes such as flat, waved, corrugated, or one or two side are waved which will be used as longitudinal convex lens when the solar apparatus need higher temperature for special use as shown in FIG. 5b;

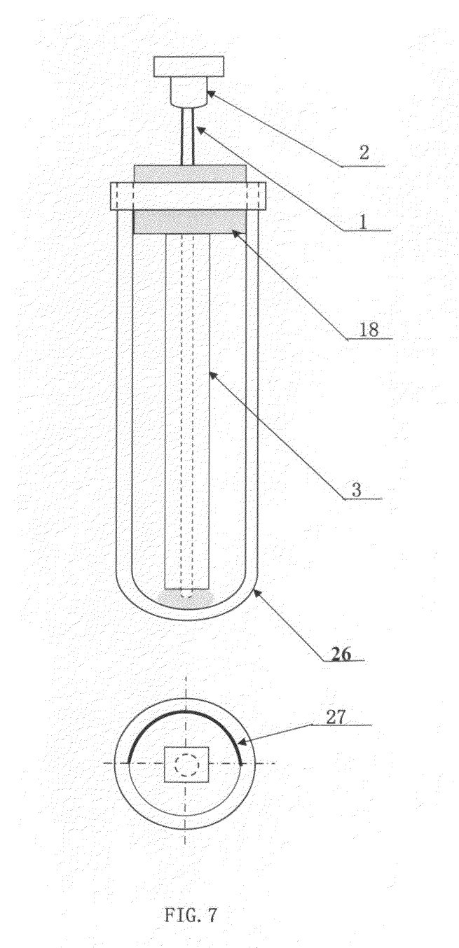

For the transparent roof cover, it shall be suitable to form reliable drain channel at longitudinal joint; the easy way is that to make the shape of transparent roof cover to be near same or similar as the one of normal metal or cement roof cover. For the flat transparent roof cover, it is preferably to be made into ‘U’ shape channel with right-angle flanges at the longitudinal sides, as showed in FIG. 5, another U channel will be installed upside down at each joint of transparent roof cover for draining; or it to be made into a special shape which is flat and with side drain channel, as showed in FIG. 6; said flat transparent roof covers in FIGS. 5 and 6, are preferably installed upside down as FIG. 5A and FIG. 6A, so that it keep a flat bottom and makes it easy to place pipe.

Said transparent cover is also shared by both the solar apparatus and the building itself and therefore, such a system will be cost highly efficient;

It is possible to install said solar apparatus of this invention behind the inner side of glass curtain wall of building; it may paves a way to resolve the light pollution problem of glass curtain wall while large amount of solar energy to be collected for utilization and/or air conditioning; the costs both for cooling and heating in different seasons for relevant building will be significantly reduced;

From FIG. 4, it is clear that the insulation (comprised of 17,18,19) is behind the solar receiving plates 4 and therefore, said insulation will never interfere the sunlight to be received and collected while the solar apparatus collect solar energy and deliver it to the storage-tanks for application the whole year around; said insulation is shared by both the solar apparatus and the building itself; based on such a configuration of this invention, therefore, it is possible that to have buildings with high efficient insulation for both heating and cooling in different seasons by competitive cost; Further more, based on this invention, it become commercially feasible that to have buildings with very low energy consumption and very low emission of carbon dioxide.

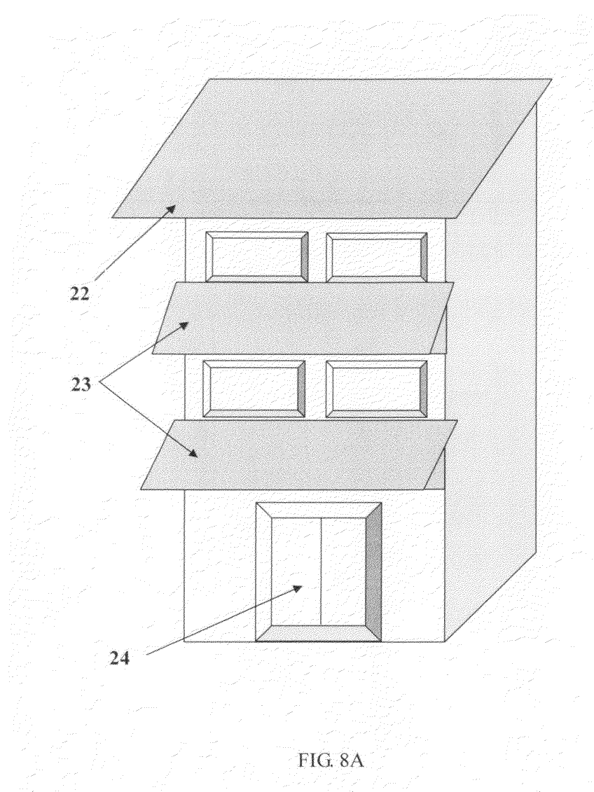

FIG. 7 shows a solar receiving units put in a glass tube with vacuum jacket, reflective focusing mirror and plug(s), in which: 1 is the body of heat-pipe or inorganic-thermal-device; 2 is the head of heat-pipe or inorganic-thermal-device; 3 is the solar energy receiving plate same as described in FIG. 1; 18 is plug made of insulation materials and the air is able to pass through it slowly to balance pressure inside and out side the glass tube; 26 is the glass tube with vacuum jacket; 27 is the reflective focusing mirror, a metal coating on the glass tube which will be inside or outside the vacuum jacket, also may be omitted while the shape and width of solar energy receiving plate is good enough to meet the desired requirement; the head of heat pipe or inorganic-thermal device is above the plug and outside the glass tube so that it will work same as the normal solar receiving units mentioned in FIG. 1 and FIG. 3 above; the sectional profile shape of said glass tube will be various such as round, ellipse, semi-round and semi-ellipse, rectangle or square or polygons with rounded corner, or shapes surrounded with various kinds of curves and/or zigzag lines depending on requirement to optimize both energy and cost efficiency; said glass tube will have 1 open on the top or 2 opens, one is on the top and another at the bottom; said open or opens will be plugged by plug(s) 18; said solar receiving units with glass tube will be installed between the said transparent cover and insulation materials as illustrated in FIG. 4, within the roof, awning, and/or wall of warehouse, factory buildings, sheds and buildings need and/or permit to do so in order to get solar energy with temperature significantly above 100° C. using for cooking, air conditioning, industry and electrical power generation by turbine and so on;

FIG. 6 shows the sectional profile shape of flat transparent roof cover with right angle flanges at the longitudinal sides

FIG. 7 shows the sectional profile shape of flat transparent roof cover with side drain channel at the longitudinal side

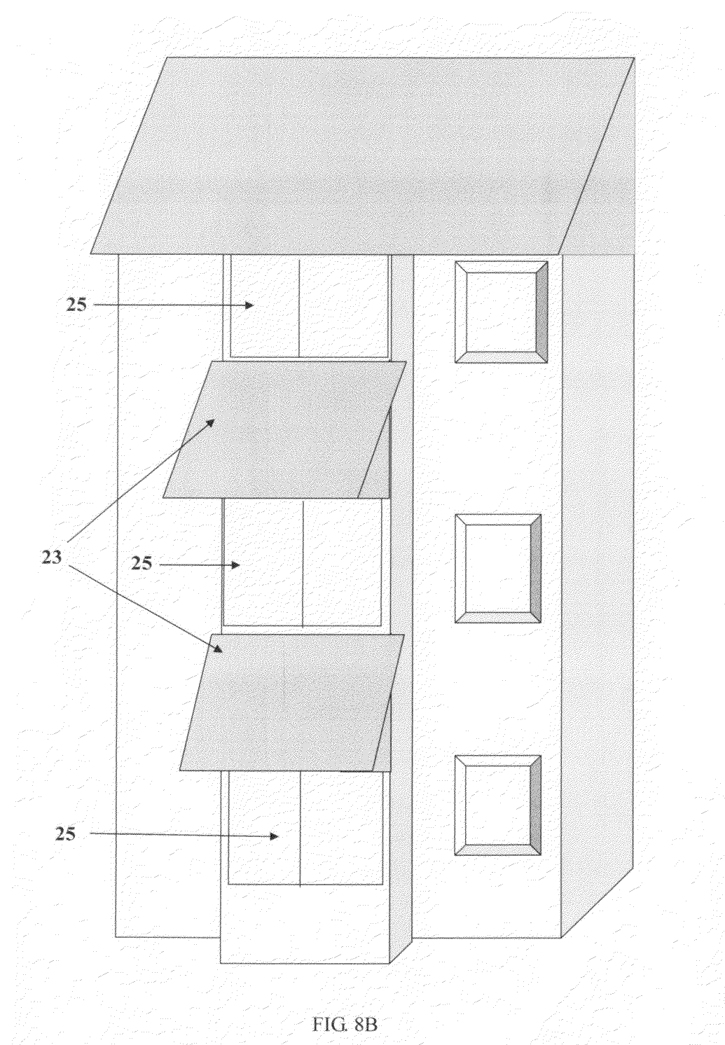

FIG. 8 shows the front views of said building-integrative solar apparatus constructed row by row on the wall with reasonable slope which improve efficiency of solar collection for tier or highrise buildings; or installed above windows and gates as awnings, 22 is the roof with solar apparatus in it; 23 is the awnings (above windows) with solar apparatus in it; 24 is the gate; 25 is the windows of balconies; for apartment buildings, to build the solar device within the walls of the apartment will benefit the residents who live in;

For existing building, said solar apparatus of this invention will be made as modules assembled and installed same way described above; it will be applied on roofs and/or on awnings and/or on walls; For renovation of existing buildings, said solar apparatus will be built within the roofs and/or awnings and/or walls during the renovation; For improving and/or extending of existing building, said solar apparatus will be built within the improving and/or extending roofs and/or awnings and/or walls during the improving and/or extending;

The apparatus and technology of this invention is also suitable for ships, boats and trains for heating, hot water supply, sea water treatment, air conditioning, cooking and the like.

The drawings and specification above provide a preferred embodiment of the invention while specific terms are in a generic and descriptive sense only and not for purposes of limitation; there is no restriction on configuration or combining of any element, factor, part, component shown in the figuration, drawing or design above, according same or similar principle or purpose;

What is claimed is:

1. a kind of solar-architectural materials and thereof a building-integrative solar heating system is characterized in that it comprised solar apparatus and utilization equipment and applications:
Said solar apparatus comprise the transparent cover for admitting sun light into the interior and isolating from the outside weathers; the solar receiving units i.e. the said solar-architectural materials which will work for both solar and architectural purpose; the heat-energy-conflux-device and insulation materials;
Said building-integrative solar heating system means that the solar apparatus will be built within the building roof and/or awnings and/or walls towards the sun light for receiving the radiant energy from the sun and converting it into heat which to be further collected via said heat-conflux-device into the metal duct or pipe within which a kind of heat-transfer-medium flows through;
Said utilization equipment include pipe, valves, heat exchanger, storage-tank(s) and/or vessel(s), or special boiler,
Said heat applications include: the common use such as building heating, hot water supply, greenhouse heating, and the higher temperature use such as air-conditioning, cooking, electrical power generation via special turbine and industrial and/or agricultural and/or commercial use;

2. said solar-architectural materials defined in claim 1 is characterized in that they comprise of metal plates with good thermal conductivity and heat-pipe or inorganic-thermal-device; said heat-pipe or inorganic-thermal-device are made integrative with the metal plate which is the solar energy absorption portion; the said metal plates have various shapes such as flat, waved, corrugated, fine or markedly dented or protruded, with or without decorative patterns and so on; and with some different dark color and with or without de-reflection coating of nice color depending on the architecture; there will be various type of edge joints between the said metal plates, such as inter locking, overlapping, inserting by tongue and groove, flange and screw, or nothing and so on, depending on the actual situations;

3. for the said architectural purpose defined in claim 1 is characterized in that the said heat-pipe or inorganic-thermal-device may have various shapes of cross-section profile, such as round, ellipse, rectangle or square or polygons normal or with rounded corner or shapes enveloped by various kinds of curves and/or zigzag lines, depending on the actual situation; the said heat-pipe or inorganic thermal device may be whole or partially located in front of the metal plate, or being hidden behind it; for width direction, the heat-pipe or inorganic-thermal-device normally is located in the middle of metal plate, but it is not limited to do so; for special purpose, a plurality of heat-pipe or inorganic-thermal-device will be made integrative with one piece of metal sheet; said metal plates or sheet will be either the same or different material as the body of heat-pipe or inorganic-thermal-device and either to be directly made integrative or made separately and then assembled integrative; depending on the architecture;

4. for the solar purpose defined in claim 1, is characterized in that the said heat-pipe or inorganic thermal devices are the heat transfer elements integrative with the metal plates which are solar energy receiving portion; the surface toward to sunlight of said metal plates and heat-pipe or inorganic thermal devices is treated by light-selective-absorbing material in order to get high efficiency of solar collection; the said heat-pipe or inorganic thermal devices have a head which has an area with special shape and perfect surface condition to meet requirement of heat-energy-conflux-device working as heat releaser where the heat energy will be transferred into a liquid medium system from heat-pipe or inorganic-thermal-device via the heat-energy-conflux-device; the section profile shape and dimension of said heads will be either same as or different from the body of heat-pipe or inorganic-thermal-device; said area with special shape can be at a side or the top of said heads depending on the actual situation; the head of heat-pipe or inorganic-thermal-device will be covered by insulation materials when they being installed in a solar system;

5. the heat-energy-conflux-device defined in claim 1 characterized in that they comprise two surfaces tightly matched each other by a set of special fitting; the heat energy is conducted by metal from the plurality of heat transfer elements, the said heat-pipe or inorganic-thermal-devices to the metal duct or pipe within which heat-transfer-medium flows through; within the roof and/or wall and/or awning, there will be no joint, no gasket on said duct or pipe; material and thickness of the duct or pipe will be designed based on parameter of the heat transfer medium within said duct and pipe without break risk; therefore, there will never be leakage possibility; among the said two surfaces tightly matched, one is on the head of said heat-pipe or inorganic-thermal-devices, another is on the metal duct or pipe within which heat-transfer-medium flows through; area of said matched surfaces depends on the material and heat energy amount to be conducted through thereby;
The section profile shape of said duct or pipe will be various, such as round, ellipse, semi-round and semi-ellipse, rectangle or square or polygons normal or with rounded corner, or shapes surrounded with various kinds of curves and/or zigzag lines, or two ducts integrated, depending on the actual situation; the key point is that the ducts have area composing sets of perfect matching surfaces with the relevant area on the heads of heat-pipe or inorganic-thermal-devices; or the duct or pipe have arrises, such as the duct or pipe with section profile shape of rhombus, rectangle or square or polygons, the matching surface on the head of heat-pipe or inorganic-thermal-devices is a “V” shape groove, combining an arris/groove match fastened and enforced tightened by a set of proper special fitting;
Said perfect matching surfaces can be at the front, or behind, preferably at the bottom, or around the said metal duct or pipe depending on the actual situation; said fitting is made from metal or graphite or other materials with good heat conductivity and being able to make two matching surfaces impinging on each other, and makes up or enhance the heat conductive capacity also; preferably, the said fitting will be integrative with either the metal ducts or pipe, or heads of heat-pipe or inorganic-thermal-devices by integrative fabrication or welding or metallurgical bonding depending on the material and heat energy amount to be conducted through thereby; there will be or without heat-conductive agent between the said two surfaces tightly matched, depending on the actual situation;
said metal duct or pipe, body portion of heat pipe or inorganic-thermal-device above the solar energy receiving plate and fitting of thermal-energy-conflux-device will be covered by a specially designed decoration to hide the things which look like not very nice;

6. said transparent cover as defined in claim 1, is characterized in that it is comprised of glass or tempered glass or board of synthetic transparent materials; it will be single layer or double even multi layers depending on the local weather and temperature requirement of the system; for said double and/or multi layers, it will be comprised of same material or compound of different materials; it preferably be treated as de-reflecting in order to get higher efficiency; it may be treated with obscured decoration pattern or design on inside surface but without influence on sun light pass through; said transparent cover have various shapes such as flat, waved, corrugated, or one side flat and another side waved which will be used as longitudinal convex lens when the solar apparatus need higher temperature for special use;
For the roof transparent cover, it shall be suitable to form reliable drain channel at longitudinal joint. One easy way is that to make the shape of transparent roof cover to be near same or similar as the one of normal metal or cement roof cover; For the flat transparent roof cover, it is preferably to be made into ‘U’ shape channel with right-angle bending flanges at the longitudinal sides, another U channel shall be installed upside down at each joint of transparent roof cover for draining; or it to be made into a special shape which is flat and with side drain channel; said flat transparent roof cover is preferably installed upside down so that it keeps a flat bottom and make it easy to place pipe;
Said transparent cover is shared by both the solar apparatus and the building itself;

7. said insulation material defined in claim 1, is characterized in that it is comprised: Aluminum foil exterior, at least 2 layers with joint staged, to reflect infrared rays from the solar receiving portion in the day time; Boards of heat Insulation material, at least 2 layers with joints staggered, whose thickness depending on local environment temperature; Aluminum foil interior, at least 1 layers with necessary overlap at the joints, to reflect infrared rays from the building inside, also to isolate from water (humidity) migration and from air convection due to temperature difference; The building interior wall is at the back side of said Aluminum foil interior;
Heat-energy-conflux-devices have special insulation materials with aluminum foil cover and liner whose joints staggered;

8. said transparent cover as defined in claim 1 is characterized in that the glass curtain wall of building is able to be utilized for same and the solar collect units, heat-energy-conflux-devices and insulation materials defined in claim 1 is able to be installed behind the glass curtain wall of building to collect solar energy which comes into area inside the glass curtain wall for utilization and significantly reduce energy consumption both for heating in the cold season and for air conditioning in the hot season; the glass for such a configuration needs not to do semi-reflecting treatment, and it is preferred to do de-reflecting treatment to get better efficiency of solar energy collection and substantially cut down light pollution of glass curtain wall to a level near the common window glass due to that the surface of solar-architectural materials in this invention being selective absorption treated and absorb about 95% of the light energy coming onto it.

9. said building-integrative solar heating system in claim 1, is characterized in that when the said solar collect units, heat-energy-conflux-devices be built within the building roof and/or awnings, it is necessary to keep a gradient of no less than 7°, when said solar collecting units, heat-energy-conflux-devices be built within the building walls in order to get reasonable efficient, there are different solutions: to be built in vertical wall, in wall with minor slope angle, in the extra awnings especially built outside the wall toward the sun light, depending on the latitude where the building locates in; for the apartment building, to build the solar device within the walls of the apartment will benefit the residents who live in;

10. said building-integrative solar heating system in claim 1, is characterized in that the said solar collect units, heat-energy-conflux-devices will be built within the building roof and/or awnings and/or walls; specifically, said solar collect units, heat-energy-conflux-devices will be installed behind (in the wall) or below the transparent cover (in the roof and/or awning), the insulation will be behind(in the wall) or below(in the roof and/or awning) the solar collecting units and heat-energy-conflux-devices; said insulation, therefore, will never interfere the sunlight to be received and collected while the solar apparatus collect solar energy and deliver it to the storage equipment for application the whole year around; said insulation is shared by both the solar apparatus and the building itself; such a configuration of this invention, therefore, makes buildings simultaneously with both benefits: maximum solar energy collection and high efficient insulation for both heating and cooling at different time the whole day and in different season in the whole year around by reasonable cost;

11. the said higher temperature use as defined in claim 1, is characterized in that this invention provides two types of solution:
one of them is focusing sun light to the solar receiving units either by longitudinal convex lens in the transparent cover or by reflective focusing mirror at the back side of the solar receiving units;
another one is that to put the solar receiving units in a glass tube with vacuum jacket, reflective focusing mirror and plug(s) which are made of insulation materials and the air is able to pass through it slowly to balance pressure inside and out side the glass tube; the head of heat pipe or inorganic-thermal device will be above the said plug and outside the glass tube so that it will works same as the normal solar receiving units described above; the sectional profile shape of said glass tube will be various such as round, ellipse, semi-round and semi-ellipse, rectangle or square or polygons with rounded corner, or shapes surrounded with various kinds of curves and/or zigzag lines depending on requirement to optimize both energy and cost efficiency; said glass tube will have 1 open on the top or 2 opens, one is on the top and another at the bottom; said open or opens will be plugged by plug(s) mentioned above; said reflective focus mirror is a metal coating on the glass tube which may be inside or outside the vacuum jacket, also may be omitted while the shape and width of solar energy receiving plate is good enough to meet the desired requirement; said solar receiving units with glass tube will be installed between the said transparent cover and insulation materials within the roof, awning, and/or wall of warehouse, factory buildings, sheds and buildings need and/or permit to do so; in such a way to get solar energy with temperature significantly higher than 100° C.; for such a system, proper heat-transfer medium will be used both in the solar apparatus and the application system accordingly;
In the solar system of this invention, when there are plurality of heat-energy-conflux-device sets, the temperature and overall efficiency of system will be optimized via the control device by adjusting configuration of said sets according to actual situation;

12. said common use as defined in claim 1, is characterized in that, for the solar system using for building heating, hot water supply or the like where the temperature normally is not so high, the water ducts and/or pipe system of this invention is capable to work with pressure, therefore, there are two options: one is that usage water directly flow via. said duct or pipe of heat-energy-conflux-device to be heated without pump and heat exchanger; another is to use a heat-transfer-medium cycling system separating from usage water system by a heat exchanger;

13. said electrical power generation defined in claim 1 is characterized in that there will be boiler(s) heated by heat energy collected by the apparatus and technology of this invention, and turbine and condensator, those and some related equipment comprise a cycling loop, in which the working medium will be either water or others with lower boil point and evaporation latent heat than water with; it is preferably to comprise a complex application of power and heating while the turbine works with a condensator at proper temperature, for example about 60° C., and it will make high efficiency overall.

14. said building-integrative solar heating system defined in claim 1, is characterized in that for existing buildings and houses, it will be made as assembled modules and to be applied on roofs and/or on awnings and/or on walls; when the existing buildings and/or houses to be renovated, improved, extended, said solar apparatus will be built within the roofs and/or awnings and/or walls

15. said building-integrative solar heating system defined in claim 1, is characterized in that the apparatus and technology of this invention is also suitable for ships, boats and trains for heating, hot water supply, sea water treatment, air conditioning, cooking and the like.
